(19) United States
(12) Patent Application Publication
(10) Pub. No.: US 2016/0246085 A1
(43) Pub. Date: Aug. 25, 2016

(54) LIQUID CRYSTAL PANEL AND MANUFACTURING METHOD THEREOF

(71) Applicant: SHENZHEN CHINA STAR OPTOELECTRONICS TECHNOLOGY CO., LTD., Shenzhen, Guangdong (CN)

(72) Inventors: Xinhui ZHONG, Shenzhen, Guangdong (CN); Yungjui LEE, Shenzhen, Guangdong (CN)

(73) Assignee: Shenzhen China Star Optoelectronics Technology Co., Ltd., Shenzhen, Guangdong (CN)

(21) Appl. No.: 14/422,683

(22) PCT Filed: Nov. 6, 2014
(86) PCT No.: PCT/CN2014/090469

§ 371 Date: Feb. 19, 2015

(30) Foreign Application Priority Data
Oct. 27, 2014 (CN) 201410583473.9

(51) Int. Cl. G02F 1/1334; G02F 1/1343; G02F 1/1335

(52) U.S. Cl. CPC G02F 1/1334; G02F 1/133528; G02F 1/134363; G02F 2001/133531; G02F 2001/133538

(57) ABSTRACT

The present invention provides a liquid crystal panel and a manufacturing method thereof. The liquid crystal panel is used for a field sequence color display mode and includes a first substrate (1), a second substrate (2), a liquid crystal layer (3), an upper polarizer (11) arranged on a surface of the first substrate (1) distant from the liquid crystal layer (3), a lower polarizer (21) arranged on a surface of the second substrate (2) distant from the liquid crystal layer (3), and a comb electrode (22) arranged on a surface of the second substrate (2) adjacent to the liquid crystal layer (3). The liquid crystal layer (3) is of a polymer-dispersed liquid crystal structure and includes a polymer layer (32) and liquid crystal drops (31) dispersed in the polymer layer (32). The upper polarizer (11) and the lower polarizer (21) have axes that are perpendicular to each other and are each slanted with respect to the comb electrode (22). The comb electrode (22) generates a horizontal electric field to drive liquid crystal molecules contained in the liquid crystal drops (31). The liquid crystal panel has a fast response speed and high contrast.

### BACKGROUND OF THE INVENTION

1. Field of the Invention

The present invention relates to the field of displaying technology, and in particular to a liquid crystal panel and a manufacturing method thereof.

2. The Related Arts

A liquid crystal display (LCD) comprises an enclosure, a liquid crystal panel arranged in the enclosure, and a backlight module mounted in the enclosure. The liquid crystal panel is composed of a color filter (CF) substrate, a thin-film transistor (TFT) array substrate, and a liquid crystal layer filled between the two substrates. The CF substrate and the TFT substrate have inside surfaces that face each other and are provided with transparent electrodes formed thereon. The liquid crystal display applies an electric field to control the orientation of the liquid crystal molecules so as to change the polarization state of light and uses a polarizer to selectively achieve transmission or blocking of a light path so as to achieve the purpose of displaying.

Active TFT-LCD display devices have recently made a greatly progress and have gained wide applications. The TFT-LCD liquid crystal panels that are available as the main stream in the market are classified in three categories, which are respectively twisted nematic/super twisted nematic (TN/STN) type, in-plane switching (IPS) type, and vertical alignment (VA) type. Although the operations that these three types of liquid crystal display panel take to control the liquid crystal displaying are different, the essential structures of them are similar and can be represented by the structure illustrated in FIG. 1, which comprises a CF substrate 100, a TFT substrate 200, a top polarizer 110, a bottom polarizer 210, and a liquid crystal layer 300.

However, the liquid crystal panel itself does not give off light and needs a backlight module to supply light. Since an LCD has low transmittance, most of the backlighting is simply wasted and the utilization of light of the LCD is low. The transmittance of an LCD being low is a result of various factors, including polarizer, color filter, and electrode, they exhibit an effect of shielding and absorbing light. To increase light utilization of an LCD, a field sequence color display mode has been proposed, in which a liquid crystal panel contains no color filter, while coloring is achieved by alternately and cyclically displaying multiple colors of R (Red), G (Green), and B (Blue), so that theoretically, light transmittance and light utilization can be increased by three times of the original level. However, the field sequence color display mode LCD requires an extreme fast response speed of the liquid crystal panel. Heretofore, a blue phase liquid crystal display is the only one that satisfies the requirement. However, the blue phase display suffers certain technical issues, including a narrow range of manufacturing process and a high driving voltage. It is thus desired to develop a novel fast-responding liquid crystal display mode.

A polymer-dispersed liquid crystal (PDLC) display mode is a liquid crystal display mode in which a liquid crystal medium is dispersed in a polymer layer through a polymerization induced phase separation technique and scattering of incident light is controlled to adjust transmission of light. An essential structure of a liquid crystal panel applied to the PDLC display mode is illustrated in FIGS. 2 and 3, which comprises an upper glass substrate 10, a lower glass substrate 20, a liquid crystal layer 30 interposed between the upper and lower substrates 10, 20, and other structures between the upper and lower substrates 10, 20, such as an indium tin oxide (ITO) pixel electrode, a data signal line, a gate line, a photo spacer. Such a structure requires no polarizer. The liquid crystal layer 30 contains not only liquid crystal molecules, but also polymerizable monomers that are sensitive to ultraviolet (UV) light. As shown in FIG. 2, before irradiation of UV light to the liquid crystal layer 30, the liquid crystal molecules and the polymerizable monomers are distributed disorderly. As shown in FIG. 3, after irradiation of UV light to the liquid crystal layer 30, the polymerizable monomers start up a polymerization reaction and form a polymer layer 302, while the liquid crystal molecules form liquid crystal drops 303 distributed in the polymer layer 302. As shown in FIGS. 4-5, the liquid crystal panel of the PDLC display mode comprises pixel electrodes that are constituted by parallel electrodes 101, 201 that are arranged on opposing inside surfaces of the upper and lower substrates 10, 20. Application of a voltage between the parallel electrodes 101, 201 establishes a vertical electric field. As shown in FIG. 4, before the application of the voltage, the liquid crystal molecules contained the liquid crystal drops 303 are in a random arrangement, so that the incident light is subjected to refraction, reflection, and diffraction at interfaces between the liquid crystal drops 303 and the polymer layer 302 and randomly arranged liquid crystal molecules within the liquid crystal drops 303, whereby the incident light that is generally in a collimated form is changed to a random scattered condition, making the panel showing a dark state of being obscure and hazy. As shown in FIG. 5, upon application of a voltage, the liquid crystal molecules contained in the liquid crystal drops 303 are acted upon by the electric field to align in the direction of the electric field so that the incident light is allowed to maintain the original travel direction, making the panel showing a transparent condition.

Since the liquid crystal panel of the PDLC display mode contains no polarizer, the dark state is simply scattering of light, but the brightness is still high. Thus, liquid crystal panels of this kind have a low contrast and reduced levels of gray scaling so that no application has been made to displaying of messages of a large amount, making them just suitable for low-end applications, such as a glass door of a shower room, a screen or window covering of an office, and an external glass wall of a building for adjusting light transmission or control of switching between a transparent condition and a non-transparent condition.

### SUMMARY OF THE INVENTION

An object of the present invention is to provide a liquid crystal panel, which is applicable to a field sequence color display mode and achieves fast response and has high contrast and is capable of increasing light transmittance and utilization.

An object of the present invention is also to provide a manufacturing method of a liquid crystal panel, which provides the liquid crystal panel with a relatively fast response speed, a relatively high contrast, and relatively high light transmittance and utilization.

To achieve the above object, the present invention provides a liquid crystal panel, which comprises: a first substrate, a second substrate opposite to the first substrate, a liquid crystal layer between the first substrate and the second substrate, an upper polarizer arranged on a surface of the first substrate that is distant from the liquid crystal layer, a lower polarizer arranged on a surface of the second substrate that is distant from the liquid crystal layer, and a comb electrode arranged on a surface of the second substrate that is adjacent to the liquid crystal layer. The liquid crystal layer is of a polymer-dispersed liquid crystal structure, which comprises a polymer layer and liquid crystal drops dispersed in the polymer layer. The upper polarizer and the lower polarizer have axes that are perpendicular to each other and are each slanted with respect to the comb electrode. The comb electrode is operable to generate a horizontal electric field to drive liquid crystal molecules contained in the liquid crystal drops.

The axes of the upper polarizer and the lower polarizer are each set to form an included angle of 45 degrees with respect to the comb electrode.

The liquid crystal drops are of an ellipsoidal form.

The liquid crystal drops have a size of 20 nm-200 nm and the liquid crystal drops is smaller than visible light wavelength.

The comb electrode comprises pixel electrodes and common electrodes. The pixel electrodes and the common electrodes are arranged to be alternate with and spaced from each other in a horizontal direction.

The liquid crystal layer is formed by subjecting a mixture of polymerizable monomers and liquid crystal molecules to irradiation of ultraviolet light or heating.

The polymerizable monomers is one of acrylic ester and derivatives thereof, methacrylate ester and derivatives thereof, styrene and derivatives thereof, epoxy resin and fatty amine epoxy curing agents or a composition thereof.

The polymerizable monomers take a percentage of 10-50% of the mixture.

The present invention also provides a liquid crystal panel, which comprises: a first substrate, a second substrate opposite to the first substrate, a liquid crystal layer between the first substrate and the second substrate, an upper polarizer arranged on a surface of the first substrate that is distant from the liquid crystal layer, a lower polarizer arranged on a surface of the second substrate that is distant from the liquid crystal layer, and a comb electrode arranged on a surface of the second substrate that is adjacent to the liquid crystal layer, the liquid crystal layer being of a polymer-dispersed liquid crystal structure, which comprises a polymer layer and liquid crystal drops dispersed in the polymer layer, the liquid crystal drops being of an ellipsoidal form, the upper polarizer and the lower polarizer having axes that are perpendicular to each other and are each slanted with respect to the comb electrode, the comb electrode being operable to generate a horizontal electric field to drive liquid crystal molecules contained in the liquid crystal drops;

the comb electrode comprising pixel electrodes and common electrodes, the pixel electrodes and the common electrodes being arranged to be alternate with and spaced from each other in a horizontal direction.

The axes of the upper polarizer and the lower polarizer are each set to form an included angle of 45 degrees with respect to the comb electrode.

The liquid crystal drops have a size of 20 nm-200 nm and the liquid crystal drops is smaller than visible light wavelength.

The liquid crystal layer is formed by subjecting a mixture of polymerizable monomers and liquid crystal molecules to irradiation of ultraviolet light or heating.

The polymerizable monomers is one of acrylic ester and derivatives thereof, methacrylate ester and derivatives thereof, styrene and derivatives thereof, epoxy resin and fatty amine epoxy curing agents or a composition thereof.

The polymerizable monomers take a percentage of 10-50% of the mixture.

The present invention further provides a manufacturing method of a liquid crystal panel, which comprises the following steps:

(1) providing a first substrate and a second substrate opposite to the first substrate, the first substrate having a surface that is distant from the second substrate and comprises an upper polarizer arranged thereon, the second substrate having a surface that is distant from the first substrate and comprises a lower polarizer arranged thereon, the second substrate having a surface that is adjacent to the first substrate and comprises a comb electrode arranged thereon,

wherein the upper polarizer and the lower polarizer have axes that are perpendicular to each other and are both slanted with respect to the comb electrode;

(2) arranging a mixture of liquid crystal molecules and polymerizable monomers between the first substrate and the second substrate,

wherein in the mixture, the polymerizable monomers take a percentage of 10-50%; and

(3) subjecting the mixture to irradiation of ultraviolet light or heating to induce a polymerization reaction of the polymerizable monomers to form a polymer layer and liquid crystal drops dispersed in the polymer layer,

wherein the polymer layer and the liquid crystal drops dispersed in the polymer layer collectively form a liquid crystal layer.

In step (1), the upper polarizer and the lower polarizer have axes that are respectively set at an included angle of 45 degrees with respect to the comb electrode and the comb electrode comprises pixel electrodes and common electrodes, the pixel electrodes and the common electrodes being arranged to be alternate with and spaced from each other in a horizontal direction;

in step (2), the polymerizable monomers is one of acrylic ester and derivatives thereof, methacrylate ester and derivatives thereof, styrene and derivatives thereof, epoxy resin and fatty amine epoxy curing agents or a composition thereof;

in step (3), the ultraviolet light irradiation or heating performed with a baking oven, ultrasonic wave, or infrared heating is carried out in a temperature range of -30° C. to 120° C.; and

the liquid crystal drops are of an ellipsoidal form and have a size of 20 nm-200 nm, the liquid crystal drops are smaller than visible light wavelength.

The efficacy of the present invention is that the present invention provides a liquid crystal panel, which includes no color filter and comprises upper and lower polarizers that are additionally included on the basis of a conventional liquid crystal panel used for a PDLC display mode so that the liquid crystal panel shows increased contrast and also increases light transmittance and utilization. Further, since liquid crystal drops dispersed in the polymer layer is small, the liquid crystal panel has fast response speed and is applicable to a field sequence color display mode. The present invention also provides a manufacturing method of a liquid crystal panel, which provides a liquid crystal panel with an increased response speed, increased contrast, and improved light transmittance and utilization.

### BRIEF DESCRIPTION OF THE DRAWINGS

The technical solution, as well as other beneficial advantages, of the present invention will be apparent from the following detailed description of embodiments of the present invention, with reference to the attached drawing.

In the drawing:

FIG. 1 is a schematic cross-sectional view of a conventional liquid crystal panel;

FIG. 2 is a schematic cross-sectional view illustrating a conventional liquid crystal panel applicable to a PDLC display mode in a condition before irradiation of UV light to a liquid crystal layer;

FIG. 3 is a schematic cross-sectional view illustrating the conventional liquid crystal panel applicable to the PDLC display mode in a condition after irradiation of UV light to a liquid crystal layer;

FIG. 4 is a schematic cross-sectional view illustrating a conventional liquid crystal panel applicable to a PDLC display mode in a condition before application of voltage;

FIG. 5 is a schematic cross-sectional view illustrating the conventional liquid crystal panel applicable to the PDLC display mode in a condition after the application of voltage;

FIG. 6 is a cross-sectional view showing a liquid crystal panel according to the present invention;

FIG. 7 is a diagram illustrating the relationship between axial directions of upper and lower polarizers of the liquid crystal panel of the present invention and a comb electrode;

FIG. 8 is a schematic cross-sectional view showing the liquid crystal panel of the present invention in a condition before application of voltage;

FIG. 9 is a schematic view illustrating an arrangement of liquid crystal molecules contained in a liquid crystal drop of FIG. 8;

FIG. 10 is a schematic cross-sectional view showing the liquid crystal panel of the present invention in a condition after the application of voltage;

FIG. 11 is a schematic view illustrating an arrangement of liquid crystal molecules contained in a liquid crystal drop of FIG. 10;

FIG. 12 is a flow chart illustrating a manufacturing method of a liquid crystal panel according to the present invention;

FIG. 13 is a schematic view illustrating a second step of the manufacturing method of the liquid crystal panel according to the present invention; and

FIG. 14 is a schematic view illustrating a third step of the manufacturing method of the liquid crystal panel according to the present invention.

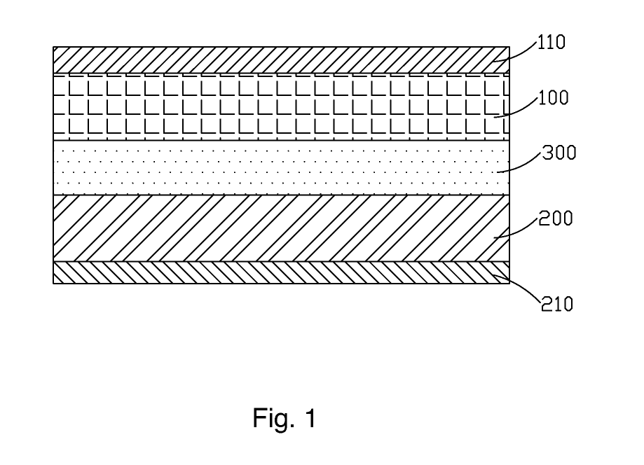

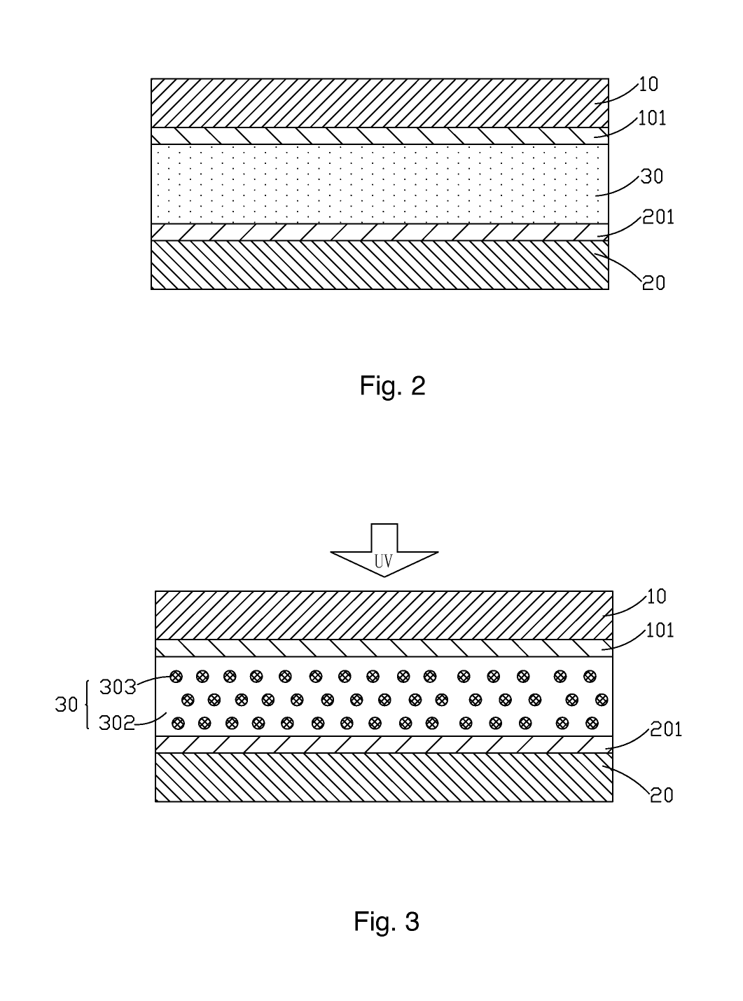

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

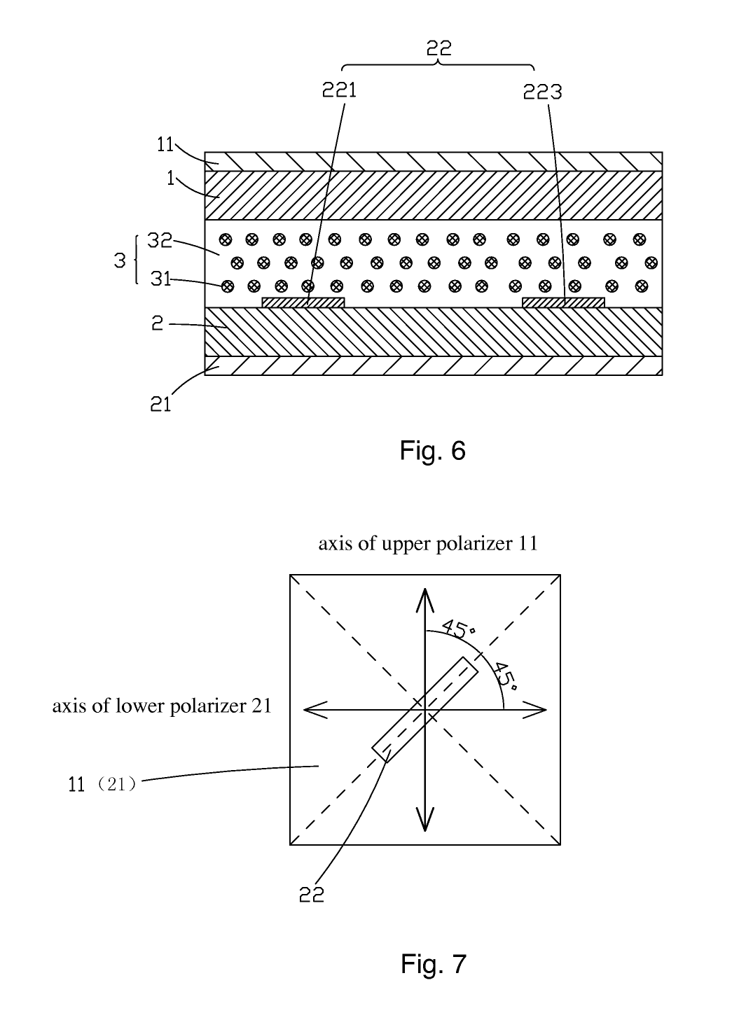

Referring to FIGS. 6 and 7, the present invention provides a liquid crystal panel, which comprises: a first substrate 1, a second substrate 2 opposite to the first substrate 1, a liquid crystal layer 3 between the first substrate 1 and the second substrate 2, an upper polarizer 11 arranged on a surface of the first substrate 1 that is distant from the liquid crystal layer 3, a lower polarizer 21 arranged on a surface of the second substrate 2 that is distant from the liquid crystal layer 3, and a comb electrode 22 arranged on a surface of the second substrate 2 that is adjacent to the liquid crystal layer 3.

Specifically, the first substrate 1 and the second substrate 2 are both glass substrates. The second substrate 2 further comprises data signal lines, thin-film transistor (TFT) switch lines, TFT switch devices, a black matrix, and photo spacers formed thereon. In other words, the second substrate 2 is similar to a TFT substrate of a conventional well-known liquid crystal panel. It is noted that the first substrate 1 comprises no color filter formed thereon and thus, compared to the conventional well-known liquid crystal panel, can reduce the effect of shielding and absorbing light thereby increasing light transmittance and utilization.

It is particularly mentioned here that the liquid crystal layer 3 is of a polymer-dispersed liquid crystal structure, which comprises a polymer layer 32 and liquid crystal drops 31 dispersed in the polymer layer 32. The liquid crystal drops 31 are of an ellipsoidal form having a size of 20 nm-200 nm. In other words, the size of the liquid crystal drops 31 is less than visible light wavelength.

The comb electrode 22 functions to generate a horizontal electric field for driving liquid crystal molecules contained in the liquid crystal drops 31. The comb electrode 22 is composed of pixel electrodes 221 and common electrodes 223. The pixel electrodes 221 and the common electrodes 223 are arranged to be alternate with and spaced from each other in a horizontal direction. The pixel electrodes 221 and the common electrodes 223 are both transparent indium tin oxide (ITO) electrodes.

As shown in FIG. 7, the upper polarizer 11 and the lower polarizer 21 have axes that are perpendicular to each other and are both slanted with respect to the comb electrode 22. The formula of light transmittance according to the model that two polarizers having axes orthogonal to each other interpose therebetween a liquid crystal layer:

$$T = \frac{1}{2} {sin}^{2} 2 {Ψsin}^{2} \frac{Γ}{2}$$

where T indicates light transmittance, Ψ is an included angle between a major axis of liquid crystal and the axis of a polarizer, and ┌ represents phase delay of the liquid crystal layer. To maximum the light transmittance, the value of 2Ψ must be 90 and ┌ be 180°. Phase delay ┌ is controlled by electric field and Ψ is determined by the direction of electrode, this being that the direction of the electrode determines the distribution of the electric field and thus in turn determines the arranging direction of the liquid crystal after being affected by the electric field. The included angle Ψ is 45° for a design of optimum angle so that preferably, the axes of the upper polarizer 11 and the lower polarizer 21 are respectively set to form an included angle of 45 degrees with respect to the comb electrode 22, whereby upon application of electrical voltage, the included angle between the major axis of liquid crystal and the axis of the polarizer is 45 degrees to ensure the desired light transmittance.

Further, the liquid crystal layer 3 is formed through ultraviolet (UV) light irradiation or heating of a mixture of polymerizable monomers and liquid crystal molecules. The polymerizable monomers take a percentage of 10-50% in the mixture and have the characteristics of generating polymerization reaction to form a substance that is solid state of high molecular weight and has excellent transparency, which can be, but not limited to one of acrylic ester and the derivatives thereof, methacrylate ester and the derivatives thereof, styrene and the derivatives thereof, epoxy resin and fatty amine epoxy curing agents or a composition thereof.

When UV light is used to irradiate the mixture of the polymerizable monomers and the liquid crystal molecules, to improve UV light polymerization efficiency, a photo initiator may be introduced. The photo initiator can be benzil dimethyl ketal, benophenone, or thioanthrone, which has a content of 0.01%-1% of the content of the polymerizable monomers.

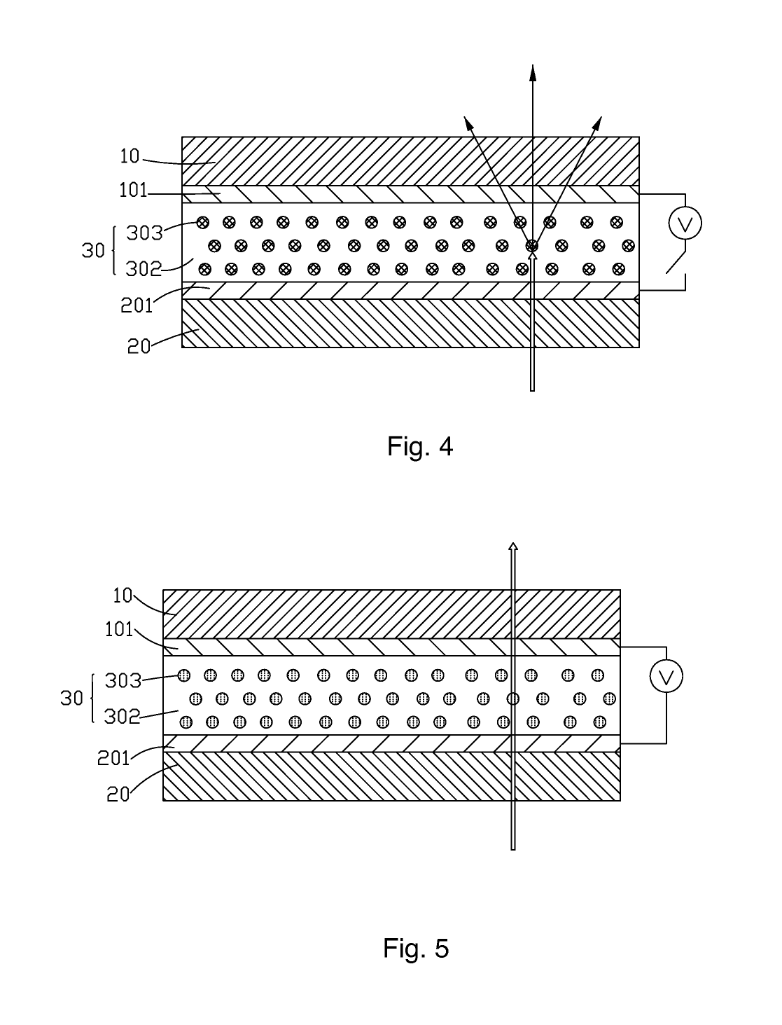

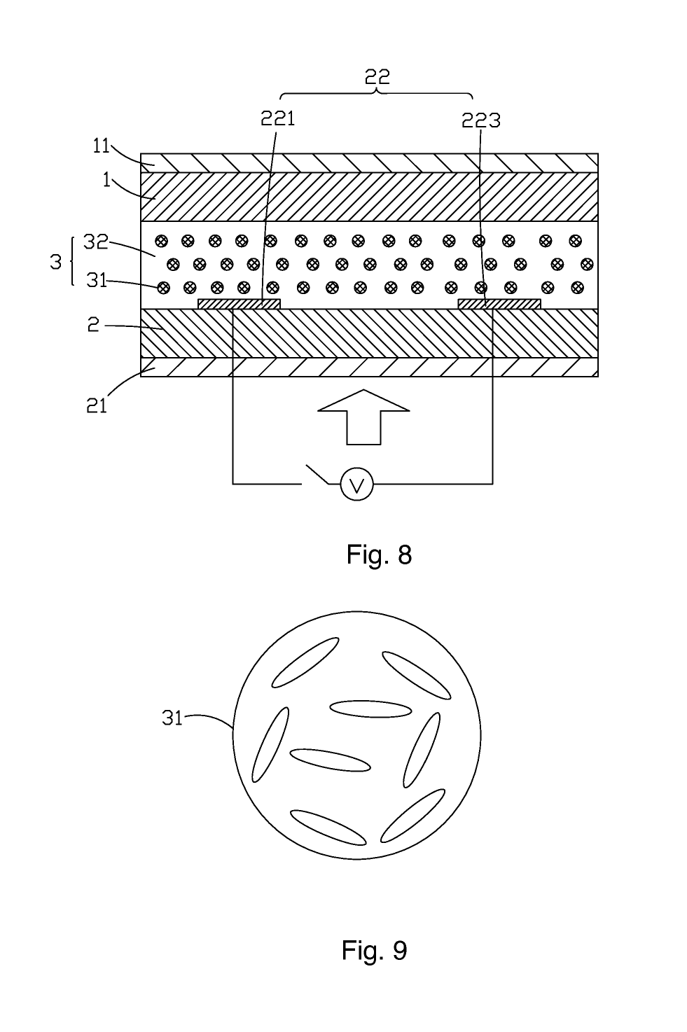

The liquid crystal panel according to the present invention comprises an upper polarizer 11 and a lower polarizer 21 and contains liquid crystal drops 31 having a size less than the visible light wavelength so that the liquid crystal panel has a structure that is different from a conventional liquid crystal panel applicable to the PDLC display mode and is different in respect of operation process and operation principle. Referring to FIGS. 8 and 9, before application of voltage, the liquid crystal molecules contained in the liquid crystal drops 31 are arranged randomly so that when backlight transmits through the lower polarizer 21 to enter the liquid crystal layer 3, since the size of the liquid crystal drops 31 is less than the visible light wavelength, even there is difference of refractivity, light may diffract around the inhomogeneous medium having small size and no phase difference will be induced so that light cannot pass through the upper polarizer 11 of which the axis is perpendicular to that of the lower polarizer 21 and the liquid crystal panel shows a dark state. For the conventional liquid crystal panel that is used with the PDLC display mode, before the application of voltage, as shown in FIG. 4, due to the influence of the interfacing between the liquid crystal drops 303 and the polymer layer 302, as well as the random arrangement of the liquid crystal molecules in the liquid crystal drops 303 and the size of the liquid crystal drops 303 being greater than the visible light wavelength, incident light is changed by reflection, refraction, and scattering into a random disordered condition, whereby the panel shows an obscure hazy condition.

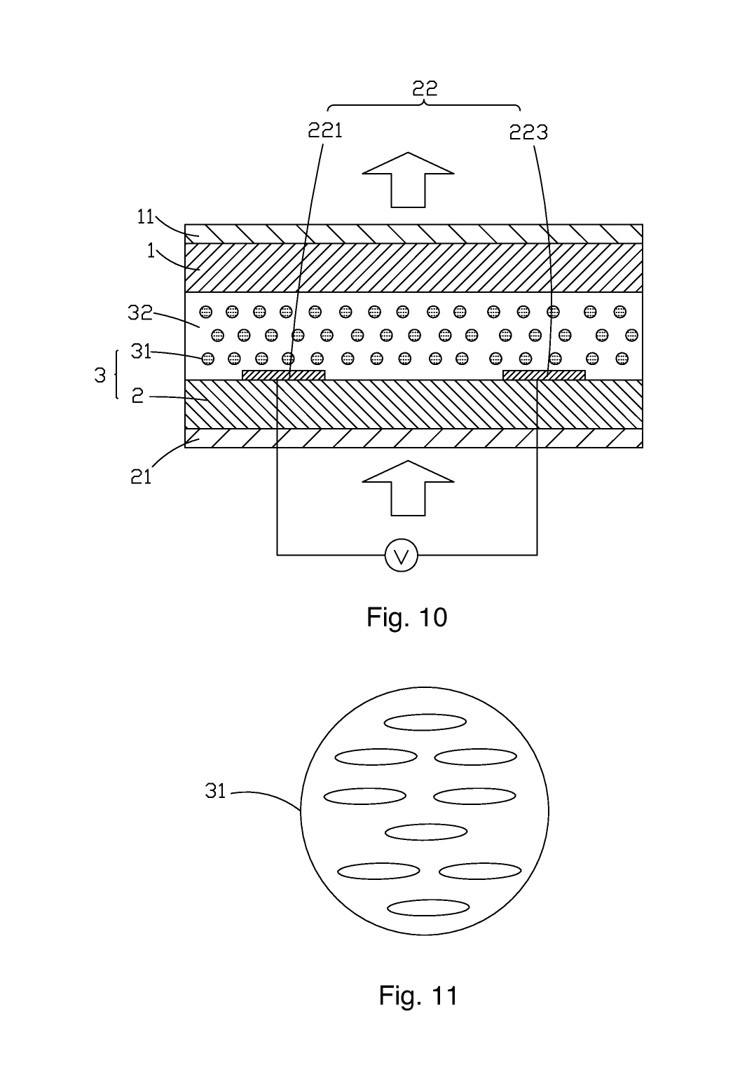

Referring to FIGS. 10 and 11, upon application of electrical voltage, the comb electrode 22 generates a horizontal electric field and the liquid crystal molecules contained in the liquid crystal drops 31 is acted upon by the horizontal electric field to rotate, whereby backlighting that transmits through the lower polarizer 21 to enter the liquid crystal layer 3 would generate a phase difference so as to be allowed to pass through the upper polarizer 11 of which the axis is perpendicular to that of the lower polarizer 21. Under this condition, the liquid crystal panel shows a bright condition for displaying. Since the axes of the upper polarizer 11 and the lower polarizer 21 are each set to form an included angle of 45 degrees with respect to the comb electrode 22, upon the application of voltage, the liquid crystal molecules contained in the liquid crystal drops 31 is oriented according to the direction of the electric field so that the major axis of the liquid crystal drops 31 form an included angle of 45 degrees with respect to the axis of the polarizer, providing an increased light transmittance. The conventional liquid crystal panel that is used for the PDLC display mode, upon application of voltage, as shown in FIG. 5, makes use of a vertical electrical field to have the major axis of the liquid crystal molecules contained in the liquid crystal drops 303 to coincide with the travel direction of the light in order to eliminate some of the scattering and thereby improving transparency. Correspondingly, the liquid crystal panel changes from the original obscure hazy condition to a transparent condition.

Assuming the liquid crystal panel of the present invention does not include the upper and lower polarizers 11, 21, regardless if a voltage is applied, the liquid crystal panel is all in the transparent condition. However, before application of voltage, the liquid crystal molecules contained in the liquid crystal drops 31 are randomly arranged so as not to generate a macroscopic phase delay effect and only upon the application of voltage, the liquid crystal molecules contained in the liquid crystal drops 31 may be arranged in a unified direction to generate a phase delay effect. Manifestly, it is because of the inclusion of the upper and lower polarizers 11, 21 in the liquid crystal panel of the present invention that the contrast of the liquid crystal panel can be greatly improved. Further, since the size of the liquid crystal drops 31 is extremely small, this corresponding to that the thickness of a liquid crystal cell is extremely small, the response speed of the liquid crystal panel can be sped up.

It is noted that the liquid crystal panel of the present invention does not include a color filter and is thus applicable to a field sequence color display mode, so that it is necessary to use a dynamic blinking backlight of red, green, and blue or other different colors to achieve color displaying.

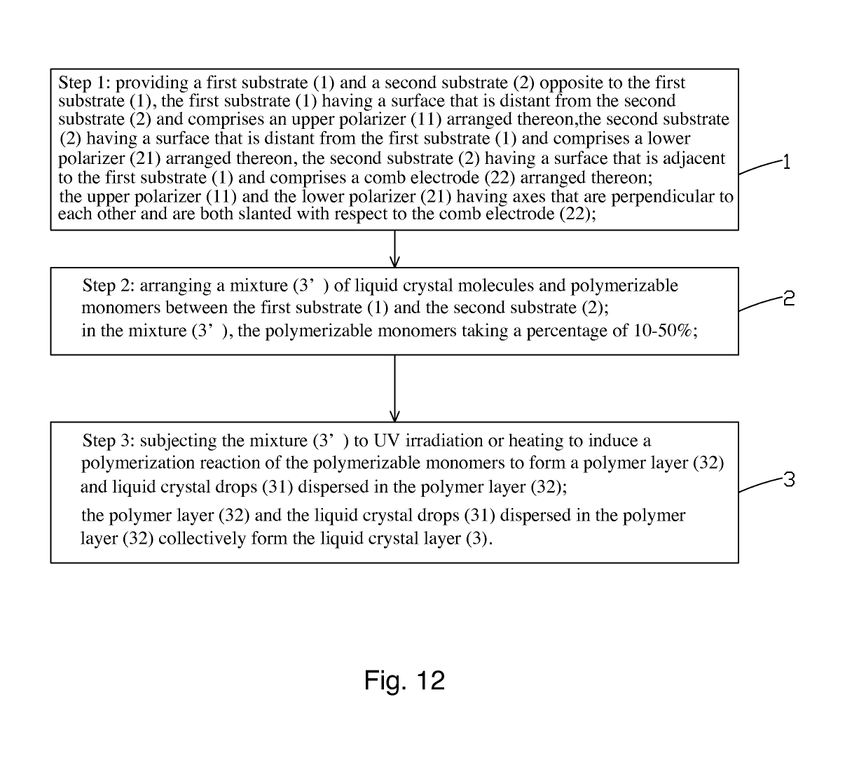

Referring to FIGS. 12-14, the present invention also provides a manufacturing method of a liquid crystal panel, which comprises the following steps:

Step 1: providing a first substrate 1 and a second substrate 2 opposite to the first substrate 1, the first substrate 1 having a surface that is distant from the second substrate 2 and comprises an upper polarizer 11 arranged thereon, the second substrate 2 having a surface that is distant from the first substrate 1 and comprises a lower polarizer 21 arranged thereon, the second substrate 2 having a surface that is adjacent to the first substrate 1 and comprises a comb electrode 22 arranged thereon.

The first substrate 1 and the second substrate 2 are both glass substrate. The second substrate 2 is similar to a TFT substrate and further comprises data signal lines, TFT switch lines, TFT switch devices, a black matrix, and photo spacers formed thereon.

The comb electrode 22 is composed of pixel electrodes 221 and common electrodes 223. The pixel electrodes 221 and the common electrodes 223 are arranged to be alternate with and spaced from each other in a horizontal direction. The pixel electrodes 221 and the common electrodes 223 are both transparent ITO electrodes.

The upper polarizer 11 and the lower polarizer 21 have axes that are perpendicular to each other and are both slanted with respect to the comb electrode 22. Preferably, the axes of the upper polarizer 11 and the lower polarizer 21 are respectively set to form an included angle of 45 degrees with respect to the comb electrode 22.

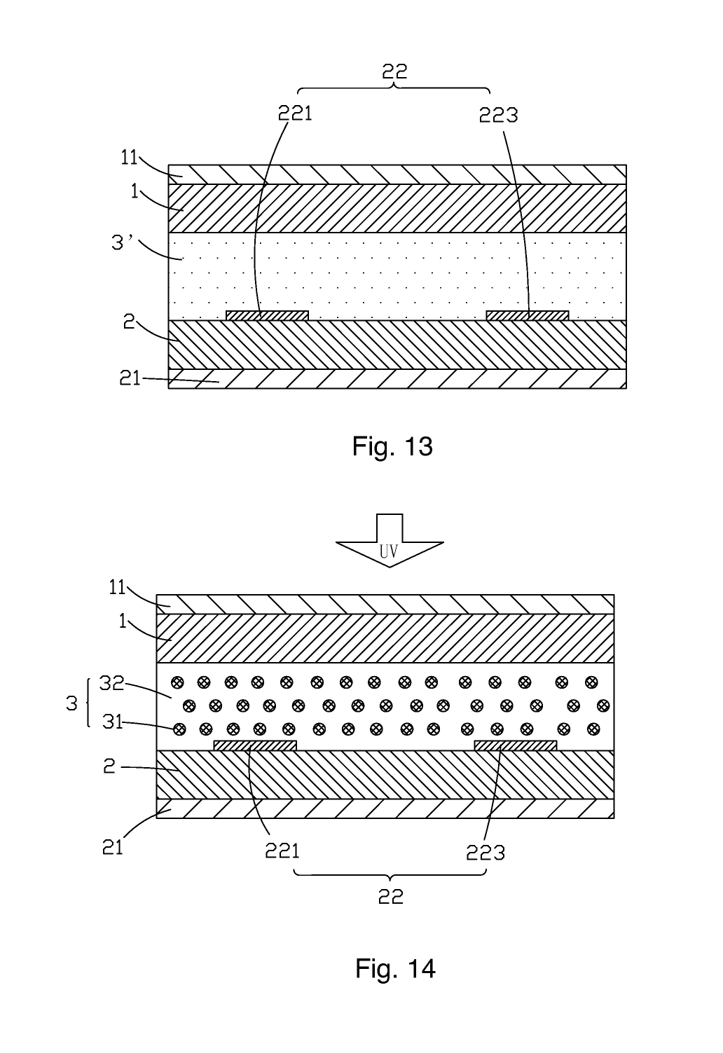

Step 2: as shown in FIG. 13, arranging a mixture 3′ of liquid crystal molecules and polymerizable monomers between the first substrate 1 and the second substrate 2.

In the mixture 3′, the polymerizable monomers take a percentage of 10-50%. In the mixture 3′, the liquid crystal molecules and the polymerizable monomers are distributed in a non-ordered manner.

The polymerizable monomers have characteristics of generating polymerization reaction to form a substance that is solid state of high molecular weight and has excellent transparency, which can be, but not limited to one of acrylic ester and the derivatives thereof, methacrylate ester and the derivatives thereof, styrene and the derivatives thereof, epoxy resin and fatty amine epoxy curing agents or a composition thereof.

Step 3: as shown in FIG. 14, subjecting the mixture 3′ to UV irradiation or heating with a baking oven, ultrasonic wave, or infrared heating within a temperature range of −30° C. to 120° C. so as to induce a polymerization reaction of the polymerizable monomers to form a polymer layer 32 and liquid crystal drops 31 dispersed in the polymer layer 32.

When UV light is used to irradiate the mixture 3′, to improve UV light polymerization efficiency, a photo initiator may be introduced. The photo initiator can be benzil dimethyl ketal, benophenone, or thioanthrone, which has a content of 0.01%-1% of the content of the polymerizable monomers.

The liquid crystal drops 31 are of an ellipsoidal form having a size of 20 nm-200 nm. In other words, the size of the liquid crystal drops 31 is less than visible light wavelength.

The polymer layer 32 and the liquid crystal drops 31 dispersed in the polymer layer 32 collectively form the liquid crystal layer 3.

To this point, the manufacture of the liquid crystal panel for use in a field sequence color display mode is completed.

The liquid crystal panel manufactured with this method is applicable to a field sequence color display mode. And, since no color filter is included, compared to a conventional liquid crystal panel, the liquid crystal panel can reduce the effect of shielding and absorbing light and thus improving light transmittance and utilization. Due to the inclusion of the upper and lower polarizers 11, 21, the contrast of the liquid crystal panel can be greatly improved. Further, since the size of the liquid crystal drops 31 is extremely small, this corresponding to that the thickness of a liquid crystal cell is extremely small, the response speed of the liquid crystal panel can be sped up.

In summary, the present invention provides a liquid crystal panel, which includes no color filter and comprises upper and lower polarizers that are additionally included on the basis of a conventional liquid crystal panel used for a PDLC display mode so that the liquid crystal panel shows increased contrast and also increases light transmittance and utilization. Further, since liquid crystal drops dispersed in the polymer layer is small, the liquid crystal panel has fast response speed and is applicable to a field sequence color display mode. The present invention also provides a manufacturing method of a liquid crystal panel, which provides a liquid crystal panel with an increased response speed, increased contrast, and improved light transmittance and utilization.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A liquid crystal panel, comprising: a first substrate, a second substrate opposite to the first substrate, a liquid crystal layer between the first substrate and the second substrate, an upper polarizer arranged on a surface of the first substrate that is distant from the liquid crystal layer, a lower polarizer arranged on a surface of the second substrate that is distant from the liquid crystal layer, and a comb electrode arranged on a surface of the second substrate that is adjacent to the liquid crystal layer, the liquid crystal layer being of a polymer-dispersed liquid crystal structure, which comprises a polymer layer and liquid crystal drops dispersed in the polymer layer, the upper polarizer and the lower polarizer having axes that are perpendicular to each other and are each slanted with respect to the comb electrode, the comb electrode being operable to generate a horizontal electric field to drive liquid crystal molecules contained in the liquid crystal drops.

2. The liquid crystal panel as claimed in claim 1, wherein the axes of the upper polarizer and the lower polarizer are each set to form an included angle of 45 degrees with respect to the comb electrode.

3. The liquid crystal panel as claimed in claim 1, wherein the liquid crystal drops are of an ellipsoidal form.

4. The liquid crystal panel as claimed in claim 1, wherein the liquid crystal drops have a size of 20 nm-200 nm and the liquid crystal drops is smaller than visible light wavelength.

5. The liquid crystal panel as claimed in claim 1, wherein the comb electrode comprises pixel electrodes and common electrodes, the pixel electrodes and the common electrodes are arranged to be alternate with and spaced from each other in a horizontal direction

6. The liquid crystal panel as claimed in claim 1, wherein the liquid crystal layer is formed by subjecting a mixture of polymerizable monomers and liquid crystal molecules to irradiation of ultraviolet light or heating.

7. The liquid crystal panel as claimed in claim 6, wherein the polymerizable monomers is one of acrylic ester and derivatives thereof, methacrylate ester and derivatives thereof, styrene and derivatives thereof, epoxy resin and fatty amine epoxy curing agents or a composition thereof.

8. The liquid crystal panel as claimed in claim 7, wherein the polymerizable monomers take a percentage of 10-50% of the mixture.

9. A liquid crystal panel, comprising: a first substrate, a second substrate opposite to the first substrate, a liquid crystal layer between the first substrate and the second substrate, an upper polarizer arranged on a surface of the first substrate that is distant from the liquid crystal layer, a lower polarizer arranged on a surface of the second substrate that is distant from the liquid crystal layer, and a comb electrode arranged on a surface of the second substrate that is adjacent to the liquid crystal layer, the liquid crystal layer being of a polymer-dispersed liquid crystal structure, which comprises a polymer layer and liquid crystal drops dispersed in the polymer layer, the liquid crystal drops being of an ellipsoidal form, the upper polarizer and the lower polarizer having axes that are perpendicular to each other and are each slanted with respect to the comb electrode, the comb electrode being operable to generate a horizontal electric field to drive liquid crystal molecules contained in the liquid crystal drops;
the comb electrode comprising pixel electrodes and common electrodes, the pixel electrodes and the common electrodes being arranged to be alternate with and spaced from each other in a horizontal direction.

10. The liquid crystal panel as claimed in claim 9, wherein the axes of the upper polarizer and the lower polarizer are each set to form an included angle of 45 degrees with respect to the comb electrode.

11. The liquid crystal panel as claimed in claim 9, wherein the liquid crystal drops have a size of 20 nm-200 nm and the liquid crystal drops is smaller than visible light wavelength.

12. The liquid crystal panel as claimed in claim 9, wherein the liquid crystal layer is formed by subjecting a mixture of polymerizable monomers and liquid crystal molecules to irradiation of ultraviolet light or heating.

13. The liquid crystal panel as claimed in claim 12, wherein the polymerizable monomers is one of acrylic ester and derivatives thereof, methacrylate ester and derivatives thereof, styrene and derivatives thereof, epoxy resin and fatty amine epoxy curing agents or a composition thereof.

14. The liquid crystal panel as claimed in claim 13, wherein the polymerizable monomers take a percentage of 10-50% of the mixture.

15. A manufacturing method of a liquid crystal panel, comprising the following steps:
(1) providing a first substrate and a second substrate opposite to the first substrate, the first substrate having a surface that is distant from the second substrate and comprises an upper polarizer arranged thereon, the second substrate having a surface that is distant from the first substrate and comprises a lower polarizer arranged thereon, the second substrate having a surface that is adjacent to the first substrate and comprises a comb electrode arranged thereon,
wherein the upper polarizer and the lower polarizer have axes that are perpendicular to each other and are both slanted with respect to the comb electrode;
(2) arranging a mixture of liquid crystal molecules and polymerizable monomers between the first substrate and the second substrate,
wherein in the mixture, the polymerizable monomers take a percentage of 10-50%; and
(3) subjecting the mixture to irradiation of ultraviolet light or heating to induce a polymerization reaction of the polymerizable monomers to form a polymer layer and liquid crystal drops dispersed in the polymer layer,
wherein the polymer layer and the liquid crystal drops dispersed in the polymer layer collectively form a liquid crystal layer.

16. The manufacturing method of the liquid crystal panel as claimed in claim 15, wherein in step (1), the upper polarizer and the lower polarizer have axes that are respectively set at an included angle of 45 degrees with respect to the comb electrode and the comb electrode comprises pixel electrodes and common electrodes, the pixel electrodes and the common electrodes being arranged to be alternate with and spaced from each other in a horizontal direction;
in step (2), the polymerizable monomers is one of acrylic ester and derivatives thereof, methacrylate ester and derivatives thereof, styrene and derivatives thereof, epoxy resin and fatty amine epoxy curing agents or a composition thereof;
in step (3), the ultraviolet light irradiation or heating performed with a baking oven, ultrasonic wave, or infrared heating is carried out in a temperature range of -30° C. to 120° C.; and
the liquid crystal drops are of an ellipsoidal form and have a size of 20 nm-200nm, the liquid crystal drops are smaller than visible light wavelength.
